(19) United States
(12) Patent Application Publication
(10) Pub. No.: US 2022/0143431 A1
(43) Pub. Date: May 12, 2022

(54) PERSONAL AIR PURIFIER

(71) Applicant: Myung Jin LEE, Seoul (KR)

(72) Inventor: Myung Jin LEE, Seoul (KR)

(21) Appl. No.: 17/429,400

(22) PCT Filed: Mar. 12, 2020
(86) PCT No.: PCT/KR2020/003416

§ 371 Date: Aug. 9, 2021

(30) Foreign Application Priority Data
Mar. 12, 2019 (KR) 10-2019-0028429

(51) Int. Cl. A62B 18/02; A62B 7/12; A62B 9/06; F24F 13/20; F24F 8/10; F24F 13/28; F24F 3/16

(52) U.S. Cl. CPC A62B 18/02; A62B 7/12; A62B 9/06; F24F 13/20; F24F 2221/12; F24F 13/28; F24F 3/16; F24F 2013/205; F24F 8/10

(57) ABSTRACT

The present invention relates to a portable personal air purifier in which there are mounted a purifier body configured to have a shape that can be carried by a user and to purify air by means of a filter, a ventilation body connected to the purifier body and configured to communicate air, and a respiration mechanism connected to the ventilation body, and configured to suck purified air; wherein the purifier body is configured such that a filter accommodating space is formed in a casing so that a filter is inserted thereinto, and the filter accommodating space has a structure in which the filter can be withdrawn in one direction; and wherein the respiration mechanism separates a ventilation line for air flowing from the purifier body and a ventilation line for air exhaled from the user.

### TECHNICAL FIELD

The present invention relates to a personal air purifier that is compact and can be used while being carried, and more particularly to a personal air purifier in which an air purifying device is directly connected to a respiration mechanism worn on a user's face so that purified air can be directly inhaled by a consumer, with the result that it can be utilized in various indoor spaces according to the consumer's needs.

### BACKGROUND ART

In general, air purifiers are devices that are installed in various spaces such as homes, offices, and business places to purify indoor air by sucking contaminated air and then discharging purified air through filters. Air purifiers prevent harmful ingredients from affecting the body's bronchial tubes and causing respiratory diseases.

Contaminants in the air include ionic components such as sulfate, nitrate, and ammonia, and harmful substances such as metal compounds and carbon compounds, and are known to be mainly generated from automobile exhaust gas.

In particular, in recent years, ultrafine dust including fine dust has been included in the air. Ultrafine dust is very small dust that is only one-fourth of the size of fine dust. Ultrafine dust is almost invisible to the human eye, but it is much smaller than fine dust. Accordingly, when it enters the respiratory tract, it cannot be filtered out of the airways and mostly penetrates into the alveoli, thereby causing heart disease and/or respiratory disease.

However, since air purifiers are not installed in some places or there is no choice but to breathe contaminated air in places having a large transient population, disposable masks that can block fine dust are mainly used.

Disposable masks are classified into yellow dust masks that block more than 80% of particles with a particle size of 0.04 to 1.0 micrometer, and disease prevention masks (KF94.99) that block 94 to 99% of particles with a particle size of 0.05 to 1.7 micrometers (KF94.99). The higher the blocking rate, the more difficult the breathing.

Accordingly, in order to facilitate breathing, there are many cases where a user does not tighten the mask tightly and a gap is often generated, resulting in failure to achieve the effect of blocking contaminants.

Therefore, recently, there has been proposed a personal air purifier of a type that can directly inhale purified air through a respirator while being portable. In a space shared by the public, such as a cafe or a library, the personal air purifier is taken out, and worn on a user's face, thereby allowing breathing with purified air.

However, the personal air purifier has drawbacks in that it does not have a compact structure, is considerably complicated, and is relatively expensive, and also has a problem in that the replacement of a filter is cumbersome.

In addition, although purified air is inhaled, the fluid does not flow smoothly because air still remains in the mask after the user exhales. To facilitate the flow of the fluid, large conduits are provided. This leads to a decrease in portability, and thus it is cumbersome to carry and use the personal air purifier, resulting in poor utilization.

### DISCLOSURE

### Technical Problem

The present invention has been contrived to solve the above-described problems, and is intended to provide an air purifier that is formed to be portable, can be used individually in various spaces, allows a user to breathe by directly inhaling purified air with a respirator while worn on the user's face, and enables smooth breathing while minimizing the volumes of flow paths, thereby improving portability.

In addition, air intake and discharge flow paths are formed to be separate and also the structures thereof are simplified, and the replacement, use and operation of a filter are facilitated.

### Technical Solution

The present invention, which is a technical spirit for achieving the above objects, provides a portable personal air purifier in which there are mounted a purifier body configured to have a shape that can be carried by a user and to purify air by means of a filter, a ventilation body connected to the purifier body and configured to communicate air, and a respiration mechanism connected to the ventilation body, and configured to suck purified air; wherein the purifier body is configured such that a filter accommodating space is formed in a casing so that a filter is inserted thereinto, and the filter accommodating space has a structure in which the filter can be withdrawn in one direction so that the filter can be selectively inserted into and withdrawn from the filter accommodation space; and wherein the respiration mechanism separates a ventilation line for air flowing from the purifier body and a ventilation line for air exhaled from the user so that breathing is achieved and purified air can be inhaled and then exhaled air can be discharged to an outside.

Furthermore, the purifier body includes a casing, a filter, a suction driving device including a fan housing and a fan, and a power supply unit, and the filter accommodating space of the casing is provided with a locking device configured to prevent separation of the accommodated filter and an elastic support means configured to induce the filter to be withdrawn by elastic restoring force when the locking device is released, so that the filter is allowed to be conveniently withdrawn or inserted.

### Advantageous Effects

According to the present invention, the personal air purifier is easy to carry because the size thereof can be reduced, and can be conveniently used in indoor areas, such as a cafe and a library, as well as in outdoor areas, by placing it at an appropriate short distance from the human body.

Furthermore, in addition to the common installation type air purifier, the personal air purifier can be individually worn on the face, and thus the inhalation of harmful air or viruses can be prevented and only purified air can be inhaled, so that the user can breathe in clean air completely, thereby preventing various diseases caused by inhaling contaminated air in advance.

Furthermore, the personal air purifier has a structure in which the filter can be inserted and withdrawn through one touch, so it is easy to replace, use, and operate the filter, and the maintenance of the filter is convenient. The intake and exhaust flow paths are simplified, and thus breathing is smoothly performed, so that user satisfaction can be increased.

Moreover, the intake and exhaust flow paths are formed in an integrated manner, and thus the manufacturing process can be simplified and the manufacturing cost can be reduced. The volumes of the flow paths are minimized, and thus the portability of the personal air purifier can be further improved.

### DESCRIPTION OF DRAWINGS

FIG. 1 is a perspective view showing a structure according to an embodiment of the personal air purifier of the present invention;

FIG. 2 is a view of the internal structure of the purifier body of the present invention;

FIG. 3 is a perspective view showing the filter mounting structure of the present invention.

FIG. 4 is a view of the filter insertion structure of FIG. 3;

FIG. 5 is a side sectional view showing the structure of the filter insertion structure of FIG. 3;

FIG. 6 is a sectional view of a state in which the filter of FIG. 5 is inserted;

FIG. 7 is a longitudinal sectional view showing the operation structure of the suction driving device of the present invention;

FIG. 8 is a detailed diagram of a structure in which a ventilation body is connected to the respiration mechanism of the present invention;

FIG. 9A is an operational state diagram showing the intake/exhaust structure of the respiration mechanism of FIG. 8;

FIG. 9B is another operational state diagram showing the intake/exhaust structure of the respiration mechanism of FIG. 8;

FIG. 10 is a perspective view of a personal air purifier according to another embodiment of the respiration mechanism of the present invention;

FIG. 11 is a detailed view of the structure of the insertion element of FIG. 10;

FIG. 12 is a view showing the state of use of FIG. 10;

FIG. 13A is an operation state diagram showing the intake/exhaust structure of the respiration mechanism of FIG. 10;

FIG. 13B is another operation state diagram showing the intake/exhaust structure of the respiration mechanism of FIG. 10; and

FIG. 14 is a perspective view showing another embodiment of a mask.

### BEST MODE

The best mode of the present invention is a portable personal air purifier in which there are mounted a purifier body configured to have a shape that can be carried by a user and to purify air by means of a filter, a ventilation body connected to the purifier body and configured to communicate air, and a respiration mechanism connected to the ventilation body, and configured to suck purified air;

wherein the purifier body is configured such that a filter accommodating space is famed in a casing so that a filter is inserted thereinto, and the filter accommodating space has a structure in which the filter can be withdrawn in one direction so that the filter can be selectively inserted into and withdrawn from the filter accommodation space; and

wherein the respiration mechanism separates a ventilation line for air flowing from the purifier body and a ventilation line for air exhaled from the user so that breathing is achieved and purified air can be inhaled and then exhaled air can be discharged to an outside.

### MODE FOR INVENTION

The present invention will be described in detail below with reference to the accompanying drawings as follows.

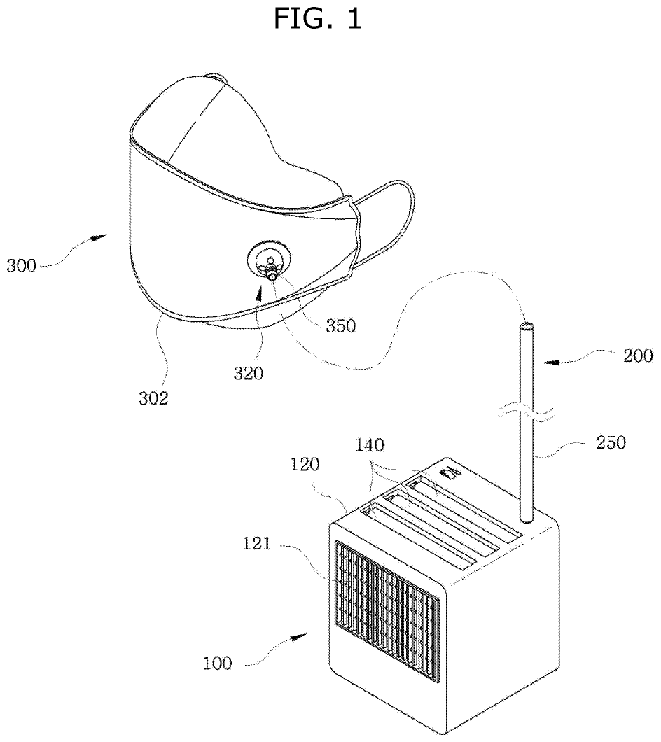

In the personal air purifier of the present invention, a purifier body 100 configured to have a shape that can be carried by a user and to purify air by means of a filter, a ventilation body 200 connected to the purifier body and configured to communicate with the purifier body in terms of air, and a respiration mechanism 300 connected to the ventilation body and configured to suck purified air are mounted, as shown in FIG. 1. The personal air purifier may be provided such that it can be carried by a user, be worn in a necessary space, and be used to allow the user to inhale purified air.

The purifier body 100 may be configured to include a casing 120, a filter 140, a suction driving device 160 including a fan housing and a fan, and a power supply unit 180.

The casing 120 constituting the exterior of the purifier body is provided such that filter accommodation spaces 122 are formed therein and accommodate filters 140. Additional accommodating spaces may be provided in ends of the casing 120, and thus the suction driving device 160 and the power supply unit 180 may be accommodated in these accommodating spaces.

An intake grill 121 configured such that external air is introduced therethrough may be provided on one side of the casing 120, preferably the front side of the casing 120. A controller 182 configured to be connected to the power supply unit 180 contained in the casing and control on/off operation or the speed of the suction driving device 160 is provided to be exposed to the outside of the casing.

In order to operate the purifier body 100, the power supply unit 180 may be configured to include a battery. A lithium ion battery is most suitable for the battery for the purpose of achieving a small size. In order to avoid the inconvenience of replacing the battery, it is preferable to install a rechargeable-type battery rather than a replacement-type battery. A charging module may be mounted therein to charge the battery.

Furthermore, the power supply unit 180 is connected to the blowing fan 164 of the suction driving device and a driving motor 165 configured to drive the blowing fan, and supplies power to them. The power supply unit, the blower fan, and the controller are each connected to a control unit (not shown), and the control unit controls the on/off operation of the power supply unit and the rotation speed of driving motor by incorporating operation signals from the controller thereinto, thereby controlling air volume during the purification of air.

Various filters capable of removing contaminants in the air may be used as the filters 140 inserted into the filter accommodation spaces 122 of the casing 120. In order to effectively remove contaminants such as ultra-fine dust in the air, there may be installed a pre-filter configured to remove relatively large dust, a HEPA filter configured to remove fine dust or ultra-fine dust, an activated carbon filter configured to remove odor, and a filter having an additional function of performing an antibacterial action or adsorbing harmful gases.

The individual filters may be configured to be separate from each other and be individually replaced, or may be inserted into one cartridge and be inserted and removed in an integrated manner. Even in the case of being inserted into one cartridge in the above manner, the individual filters may be formed to be individually separated from each other and be individually replaced.

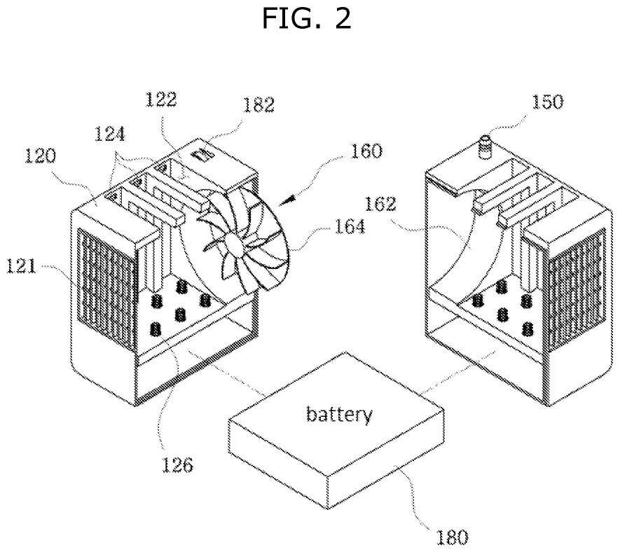

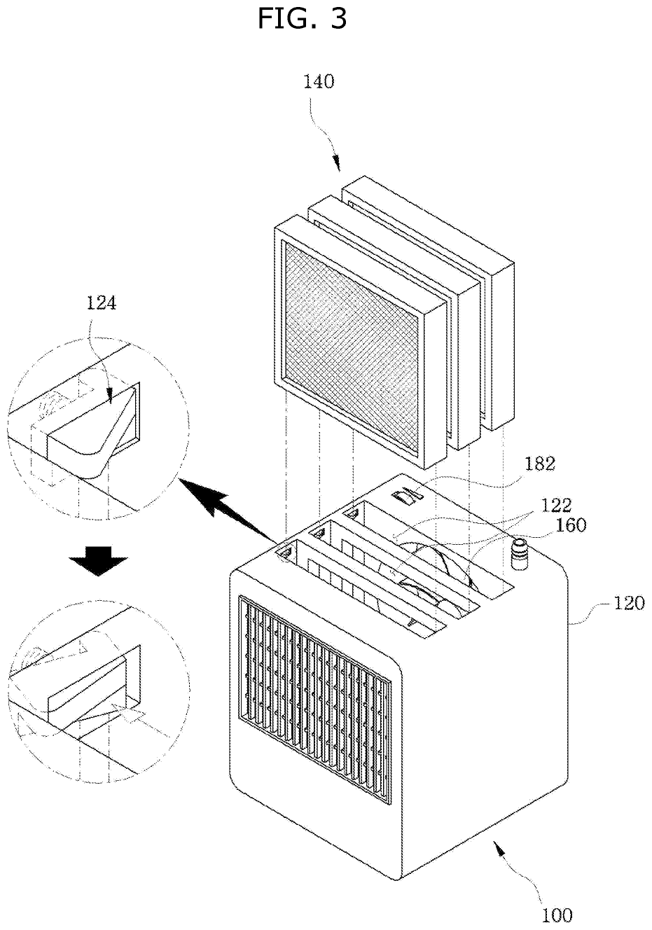

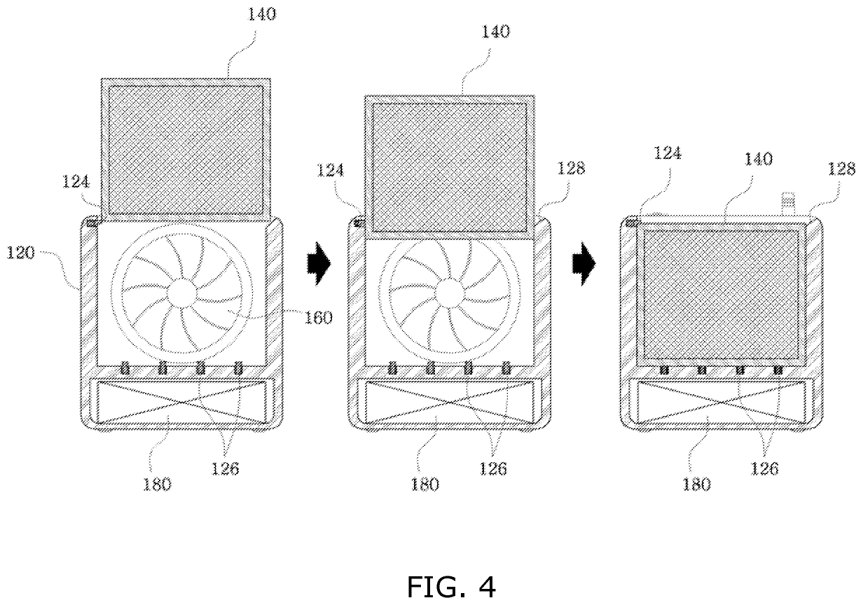

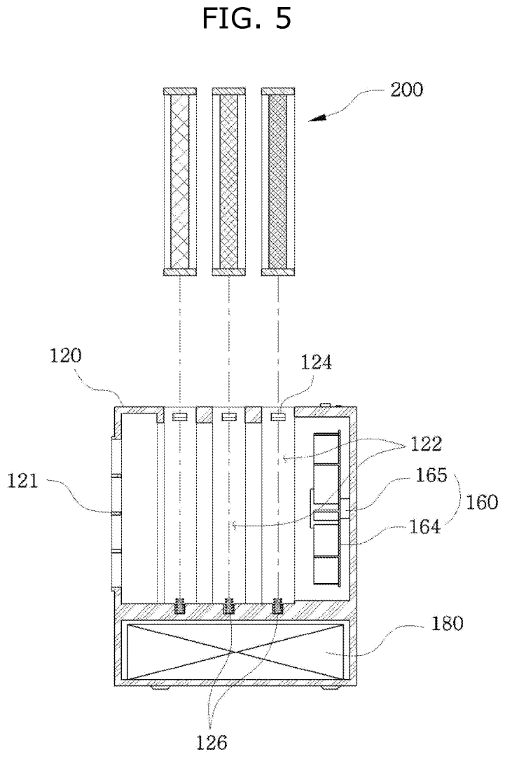

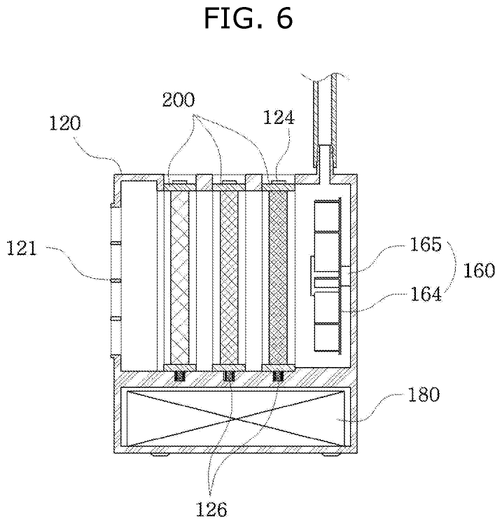

In order to accommodate the filter in each of the filter accommodating spaces 122, a locking device 124 and an elastic support means 126 may be further provided, as shown in FIGS. 2 to 4.

The locking device 124 serves to support the filter 140 not to be unintentionally separated in the state of being accommodated in the filter accommodating space. The elastic support means 126 provides elasticity so that the filter can be automatically withdrawn when the locking applied by the locking device is released.

The detailed structures of the locking device and the elastic support means will be described in more detail as follows.

The filter accommodating space 122 is an accommodating space formed in a shape in which the top side of the shape on the top of the casing 120 is opened and depression is performed toward the bottom side of the shape. The filter 140 may be slid into the filter accommodating space 122 from the top side to the bottom side and be then fastened.

In this case, the filter accommodating space 122 may be formed to correspond to the cross-sectional area so that the filter 140 does not move in the lateral direction. The edges of the filter are not moved by the partition walls, and sliding insertion is performed stably.

In this case, the filter accommodating space 122 may be divided into a plurality of compartments. For example, when the filter is formed as a triple filter, filters may be individually withdrawn by providing the filter accommodating space 122 having three corresponding compartments.

Furthermore, the filter inserted into the filter accommodating space 122 can be formed in a structure that may be individually withdrawn by a user's manipulation. In the state in which the filter 140 is inserted into the filter accommodation space 122, the locking device 124 is provided at the upper end of the filter accommodation space and prevents the filter from being separated.

The locking device 124 may be provided to be operated by a restoring means such as a coil spring or a torsion spring. By blocking or opening the entry path of the filter, it may be possible to prevent the filter from be separated or to allow the filter to be withdrawn.

In this case, the elastic support means 126 is provided at the lower end of the filter accommodating space 122, i.e., at the lower end of a portion where the filter 140 is seated, so that the filter may be provided such that elastic traction is generated upward. In this case, the elastic support means may be provided by simply disposing only a coil spring, may be provided to allow restoration to be performed by a leaf spring structure, or may be provided to additionally provide a separate support to stably pull the filter 140 upward while maintaining the level thereof.

In addition, in the filter accommodating space 122, the locking device 124 is provided on either side of the filter. An inclined surface 128 configured to allow the filter to be inserted may be further formed on the other side.

Accordingly, in the process of inserting the filter without a user pressing the locking device, the lower end edge of the filter 140 is guided along the inclined surface. In this case, the other side edge presses the locking device 124 and thus the filter accommodating space is completely opened and then guides the filter through insertion.

Accordingly, when the filter 140 is to be inserted into the filter receiving space 122, the user simply pushes the filter, and thus the fastening of the filter is completed. In contrast, in the case where the user wants to separate the filter 140 from the filter accommodating space, when the user presses the locking device 124, the filter 140 is pulled upward by the restoring force of the elastic support means 126 so that the filter can be withdrawn. Since the filter is inserted or withdrawn through one touch in this manner, the user may easily replace the expired filter.

Although the filter has been described as being individually locked and the locked structure has been described as being provided with elasticity by the elastic support means at the bottom and protruding upward in the present specification, the structures of the locking device and the elastic support means are examples illustrating the filter mounting structure of the present invention in detail. Accordingly, it is obvious that the filter mounting structure is not limited to the structure described above, and may be applied in the form of various embodiments.

For example, when the filter is pressed by pushing it downward, the mounted state of the filter is fixed. When the filter is pressed again, it is withdrawn. Even in this case, the locking device and the elastic support means may be provided at the lower end of the filter accommodating space, and may guide the filter through fastening and withdrawal. Various embodiments of a filter that is fastened using a sliding structure may be applied.

In addition, in the state in which the filter is mounted, a separate cover or lid may be additionally provided such that the mounted portion of the filter is not exposed to the outside. In this case, the cover or the lid may be formed as a separable type, or may have a structure in which one side is connected by a hinge structure and thus it is opened and closed while being folded.

Meanwhile, the suction driving device 160 may be contained inside the casing 120. The suction driving device 160 may be configured to include the fan housing 162 provided with an air guide, and the blowing fan 164 mounted inside the fan housing and configured to suck air and then discharge it.

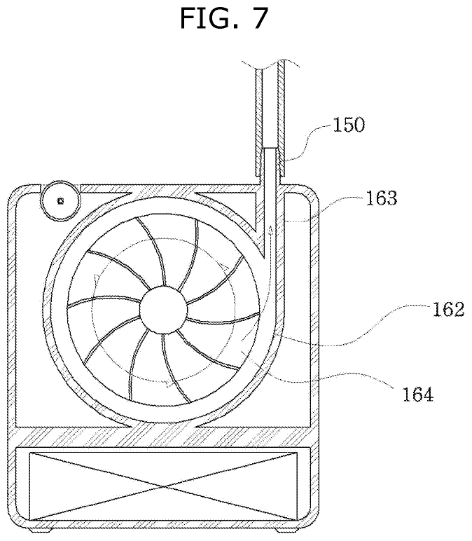

In this case, the blowing fan 164 is disposed in contact with the filter so that it is possible to filter out harmful components from the filter when the air is sucked. The air passed through the filter may be discharged to the outside through the air guide 163 of the fan housing 162 as shown in FIG. 7.

The air guide 163 of the fan housing 162 communicates with a fastening pipe body 150 formed on the outside of the casing 120 and discharges air. The fastening pipe body 150 communicates with a vent body 200 formed of a flexible material tube body 250 or the like, and guides purified air through a discharge path.

Furthermore, the other end of the tube body 250 is mounted in communication with the fastening pipe body 350 provided in the intake/exhaust element 320 of the respiration mechanism 300. The air purified by the purifier body 100 is guided to the respiration mechanism 300 via the tube body 250. The user will be able to respire while inhaling the purified air.

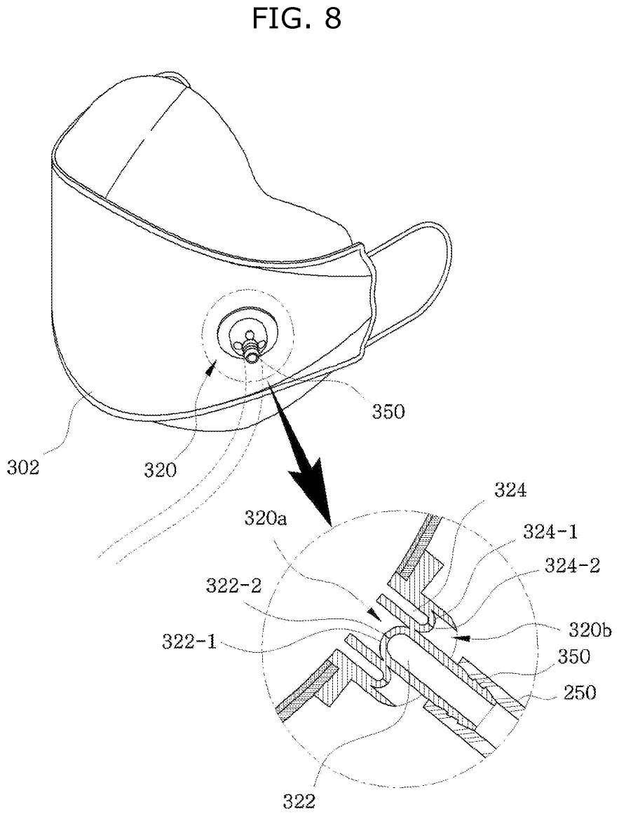

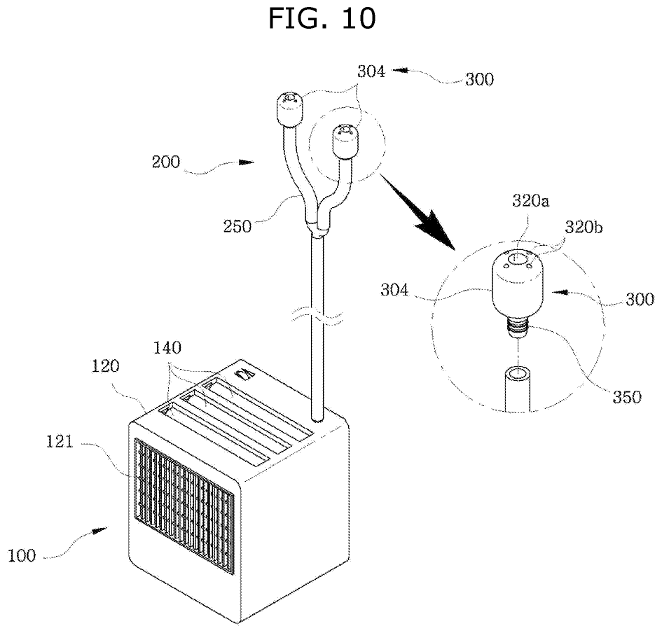

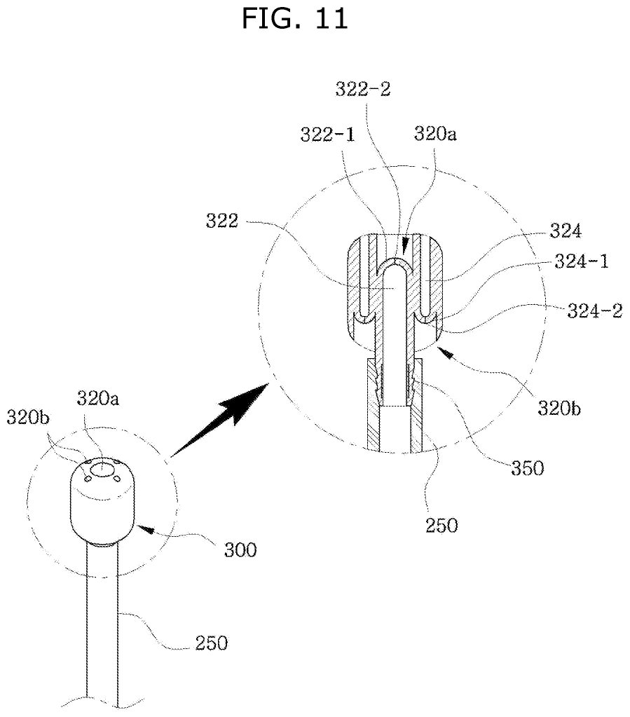

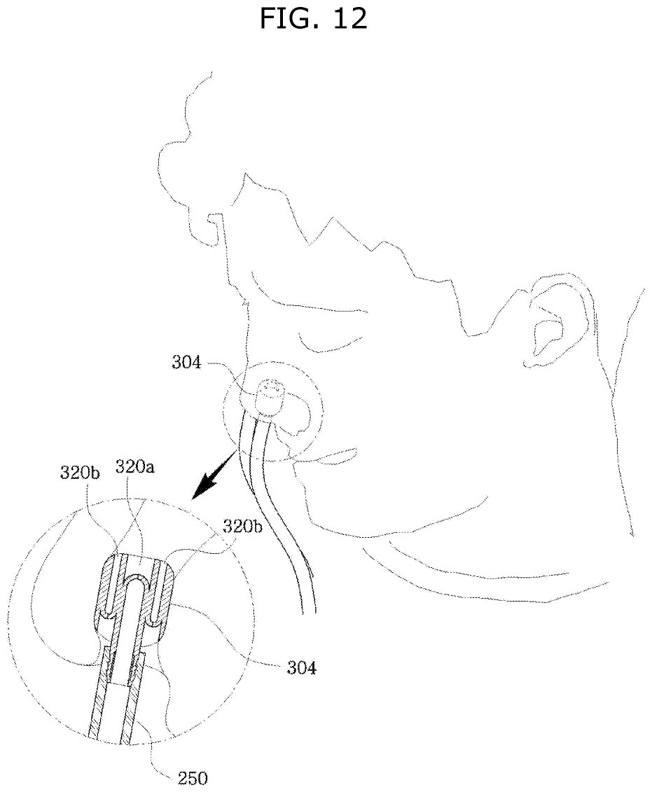

The respiration mechanism 300 may be provided as a mask 302 worn on the face as shown in FIGS. 1 and 8, may be provided as an insertion element 304 to be inserted into the nose as shown in FIGS. 10 to 12, or may be provided as a mixture of the mask and the insertion element so that the user can selectively replace and use them.

The respiration mechanism 300 is equipped with the intake/exhaust element 320. The intake/exhaust element 320 may be formed to have a structure in which an intake line 320a configured to suck purified air from the ventilation body and an exhaust line 320b configured to discharge air exhaled by the user are separated from each other. The lines separated into the intake line and the exhaust line may be formed in an integrated manner.

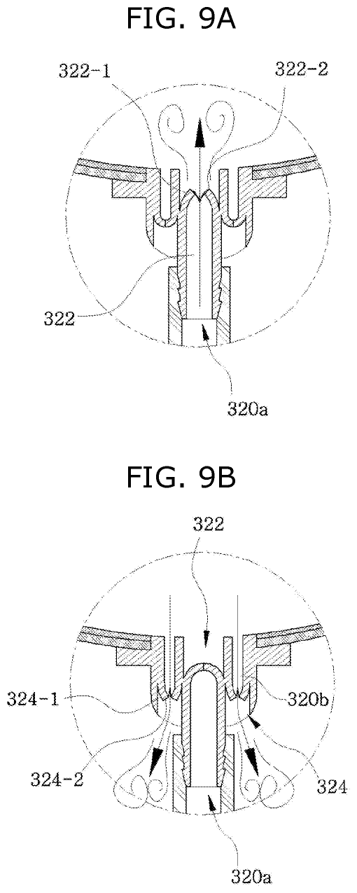

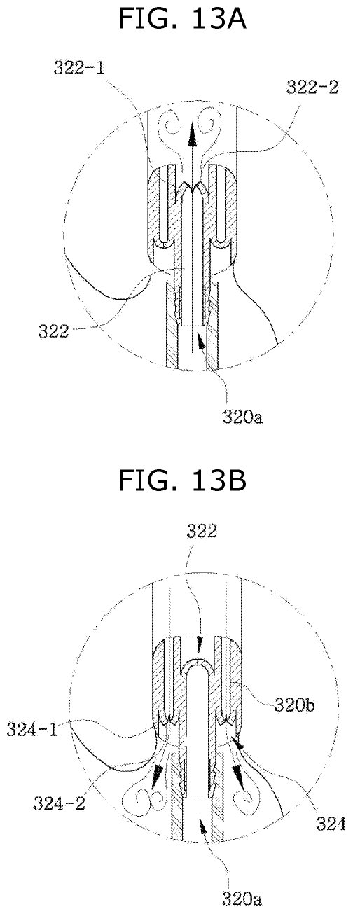

In other words, as shown in FIGS. 9A-9B and FIGS. 13A-13B, the intake/exhaust element 320 are provided such that an intake element 322 is formed to pass through the center thereof and an exhaust element 324 is formed on the edge portion thereof, so that the intake line and the exhaust line are separated from each other. The intake element and the exhaust element are each formed in a structure in which a flow path is opened in only one direction and the intake element 322 is open to a user side and the exhaust element 324 is formed to be open to the outside, and thus they are open in different directions. When the user inhales air to breathe, the purified air is introduced through the intake element 322 and the intake line 320a. When the user exhales air, the air is discharged through the exhaust element 324 and the exhaust line 320b.

To this end, blocking films 322-1 and 324-1 are formed in the intake element 322 and the exhaust element 324 to protrude in hemispherical shapes in different directions and cutting lines 322-2 and 324-2 are formed in the centers of the blocking films, so that the intake element and the exhaust element are configured to be selectively opened and closed.

Accordingly, the respiration mechanism separates a ventilation lines for the air flowing from the purifier body and the air exhaled from the user so that breathing is achieved. When the purified air is inhaled, the cutting line 322-2 of the intake element 322 is opened to open the blocking film 322-1 so that the purified air can be inhaled. In contrast, when the user exhales air, the cutting line 324-2 of the exhaust element 324 is opened to open the blocking film 324-1, so that the air exhaled by the user can be discharged to the outside.

Meanwhile, the mask 302 may be divided into a body plate configured to cover the mouth and flap parts formed on the upper and lower sides of the body plate. The body plate has built-in hard shells and thus maintains an upright state, and the flap parts move in response to the user's facial contour. In this case, an opening 310 is formed in the body plate, so that it is possible to take a drink using a straw even while wearing the mask.

The opening 310 may be positioned to correspond to the mouth of the user's face, and may have a structure that is partially cut to open and close.

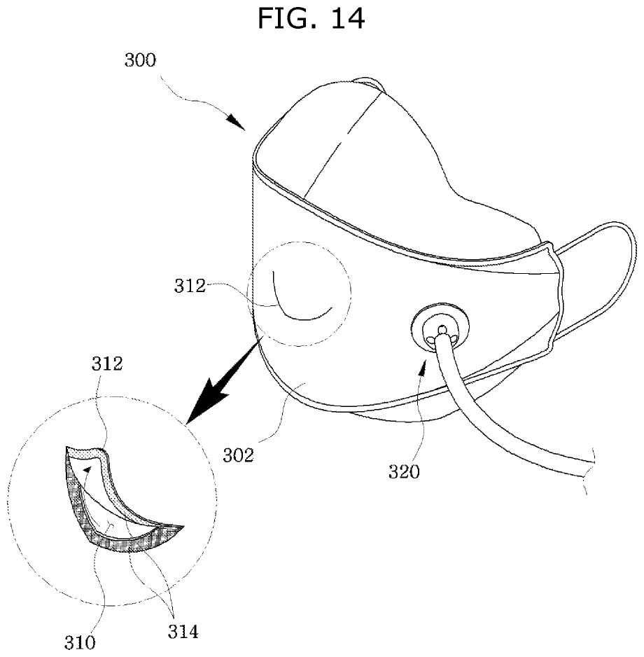

For example, as shown in FIG. 14, the opening 310 is provided in the body plate of the mask to enable drinking, and a cover plate 312 may be provided around the opening so that the opening can be selectively opened and closed.

In the state in which the cover plate is closed, an attachment/detachment element 314 such as a Velcro tape may be provided to prevent the opening from being unintentionally opened.

Furthermore, the attachment/detachment element 314 is formed along the edge of the cover plate to block outside air, so that outside air can be blocked as much as possible while the cover plate closes the opening.

What is claimed is:

1. A personal air purifier in which there are mounted a purifier body configured to have a shape that can be carried by a user and to purify air by means of a filter, a ventilation body connected to the purifier body and configured to communicate air, and a respiration mechanism connected to the ventilation body, and configured to suck purified air;
wherein the purifier body is configured such that a filter accommodating space is formed in a casing so that a filter is inserted thereinto, and the filter accommodating space has a structure in which the filter can be withdrawn in one direction so that the filter can be selectively inserted into and withdrawn from the filter accommodation space; and
wherein the respiration mechanism separates a ventilation line for air flowing from the purifier body and a ventilation line for air exhaled by the user so that breathing is achieved and purified air can be inhaled and then exhaled air can be discharged to an outside.

2. The personal air purifier of claim 1, wherein:
the purifier body includes a casing, a filter, a suction driving device including a fan housing and a fan, and a power supply unit; and
the filter accommodating space of the casing is provided with a locking device configured to prevent separation of the accommodated filter and an elastic support means configured to induce the filter to be withdrawn by elastic restoring force when the locking device is released.

3. The personal air purifier of claim 1, wherein:
the respiration mechanism includes a mask worn on a face or an insertion element inserted into a nose;
an intake/exhaust element connected to a ventilation body is mounted in the mask or the insertion element; and
the intake/exhaust element is formed in an structure in which an intake line configured to suck purified air from the ventilation body and an exhaust line configured to discharge air exhaled by the user are separated therefrom in an integrated manner.

4. The personal air purifier of claim 3, wherein the intake/exhaust element is configured such that an intake element is formed to pass through a center and an exhaust element is formed in an edge portion so that an intake line and an exhaust line are separated from each other, the intake element and the exhaust element have a structure in which flow paths thereof are each opened only in one direction, and the intake element is opened to a user side and the exhaust element is opened to an outside in different directions.

5. The personal air purifier of claim 4, wherein blocking films are formed in the intake element and the exhaust element to protrude in hemispherical shapes in different directions and cutting lines are formed in centers of the blocking films, so that the intake element and the exhaust element are configured to be selectively opened and closed.
